(19) United States
(12) Patent Application Publication
(10) Pub. No.: US 2023/0262559 A1
(43) Pub. Date: Aug. 17, 2023

(54) METHOD FOR NETWORK ACCESS CONTROL, TERMINAL, AND READABLE STORAGE MEDIUM

(71) Applicant: SPREADTRUM COMMUNICATIONS (SHANGHAI) CO., LTD., Shanghai (CN)

(72) Inventors: Jinjin NI, Shanghai (CN); Yi JIN, Shanghai (CN)

(21) Appl. No.: 18/011,988

(22) PCT Filed: Apr. 23, 2021
(86) PCT No.: PCT/CN2021/089315

§ 371 Date: Dec. 21, 2022

(30) Foreign Application Priority Data
Jun. 22, 2020 (CN) 202010574577.9

(51) Int. Cl. H04W 36/14; H04W 48/02; H04W 48/16; H04W 48/18

(52) U.S. Cl. CPC H04W 36/14; H04W 48/02; H04W 48/16; H04W 48/18; H04W 88/06

(57) ABSTRACT

A remote user equipment (UE) and a data transmission method therefor, and a storage medium are provided in the disclosure. The data transmission method for the remote UE includes the following. The remote UE receives a radio resource control (RRC) connection reconfiguration message, where the RRC connection reconfiguration message carries a configuration parameter of a relay UE, and transmits the configuration parameter to a corresponding relay UE.

### CROSS-REFERENCE TO RELATED APPLICATION(S)

This application is a National Stage of International Application No. PCT/CN2021/089315, field Apr. 23, 2021, which claims priority to Chinese Patent Application No. 2020105745779, filed Jun. 22, 2020, the entire disclosures of which are hereby incorporated by reference.

### TECHNICAL FIELD

This disclosure relates to the field of wireless communication technology, and particularly relates to a method and for network access control, a terminal, and a readable storage medium.

### BACKGROUND

At present, with the development of communication technologies, a terminal usually selects a certain network to access, so as to conduct data services. However, when the terminal selects a network to access, the terminal may be unable to access the network due to some reasons, or even unable to successfully access the network within a period of time, so that the terminal is unable to obtain network resources. In this case, the access process is time-consuming and cannot ensure that the terminal can quickly find a suitable network to access, and the network access efficiency is not high.

### SUMMARY

In a first aspect of implementations of the disclosure, a method for network access control is provided and includes: setting a flag for forbidding access to a first network standard for a first target network, and determining a second target network and a second network standard, after failing to access the first target network under the first network standard, where the first network standard and the second network standard are determined according to a terminal multi-mode, and the terminal multi-mode indicates network standards that the terminal can access; and updating the terminal multi-mode according to the second target network and the second network standard, and trying to access the second target network under the second network standard.

In combination with the first aspect, in a feasible implementation, updating the terminal multi- mode according to the second target network and the second network standard specifically includes removing the first network standard from the terminal multi-mode if the second target network is the same as the first target network and the second network standard is different from the first network standard.

In combination with the first aspect, in a feasible implementation, after successful access to the second target network under the second network standard, the method further includes: receiving an equivalent-network identifier (ID) set from the second target network, where an ID of the first target network belongs to the equivalent-network ID set; and removing the ID of the first target network from the equivalent-network ID set, when updating the equivalent-network ID set for the first network standard.

In combination with the first aspect, in a feasible implementation, the second target network is configured to be forbidden from accessing the first network standard, and the method further includes: obtaining a first duration in which the flag for forbidding access to the first network standard is set for the first target network; and removing the flag for forbidding access to the first network standard for the first target network, and restoring the first network standard back to the terminal multi-mode, if the first duration is greater than a duration threshold when accessing the second target network under the second network standard successfully.

In combination with the first aspect, in a feasible implementation, after restoring the first network standard back to the terminal multi-mode, the method further includes trying to access the first target network under the first network standard.

In combination with the first aspect, in a feasible implementation, the second target network is not configured to be forbidden from accessing the first network standard, and the method further includes obtaining the first duration in which the flag for forbidding access to the first network standard is set for the first target network; removing the flag for forbidding access to the first network standard for the first target network, if the first duration is greater than the duration threshold when accessing the second target network under the second network standard successfully; and trying to access the first network standard in the first target network, if the second target network has a lower priority than the first target network.

In combination with the first aspect, in a feasible implementation, before trying to access the first target network under the first network standard, the method further includes comparing terminal configuration with the terminal multi-mode; and updating the terminal multi-mode if the terminal configuration fails to match the terminal multi-mode. The terminal configuration failing to match the terminal multi-mode includes that the terminal does not support a service provided by one or more network standards in the terminal multi-mode, and/or the terminal currently supports a service provided by a third network standard and the third network standard has a higher priority than each network standard in the terminal multi-mode.

In combination with the first aspect, in a feasible implementation, the terminal configuration failing to match the terminal multi-mode includes that the terminal does not support the service provided by one or more network standards in the terminal multi-mode, and updating the terminal multi-mode according to a result of the comparing specifically includes removing the one or more network standards from the terminal multi-mode.

In combination with the first aspect, in a feasible implementation, the terminal configuration failing to match the terminal multi-mode includes that the terminal currently supports the service provided by the third network standard, and updating the terminal multi-mode according to a result of the comparing specifically includes adding the third network standard into the terminal multi- mode.

In a second aspect of implementations of the disclosure, an apparatus for network access control is provided and includes a determining module and a processing module. The determining module is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access. The processing module is configured to update the terminal multi-mode according to the second target network and the second network standard, and try to access the second target network under the second network standard.

In combination with the second aspect, in a feasible implementation, the processing module is configured to remove the first network standard from the terminal multi-mode if the second target network is the same as the first target network and the second network standard is different from the first network standard.

In combination with the second aspect, in a feasible implementation, after successful access to the second target network under the second network standard, the apparatus further includes a receiving module. The receiving module is configured to receive an equivalent-network identifier (ID) set from the second target network, where an ID of the first target network belongs to the equivalent-network ID set. The processing module is further configured to remove the ID of the first target network from the equivalent-network ID set, when updating the equivalent-network ID set for the first network standard.

In combination with the second aspect, in a feasible implementation, the second target network is configured to be forbidden from accessing the first network standard, and the processing module is further configured to obtain a first duration in which the flag for forbidding access to the first network standard is set for the first target network. Additionally, the processing module 302 is further configured to remove the flag for forbidding access to the first network standard for the first target network, and restore the first network standard back to the terminal multi-mode, if the first duration is greater than a duration threshold when accessing the second target network under the second network standard successfully.

In combination with the second aspect, in a feasible implementation, the processing module is further configured to try to access the first target network under the first network standard after restoring the target standard back to the terminal multi-mode.

In combination with the second aspect, in a feasible implementation, the second target network is not configured to be forbidden from accessing the first network standard, and the processing module is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In combination with the second aspect, in a feasible implementation, before trying to access the first target network under the first network standard, the processing module is further configured to compare terminal configuration with the terminal multi-mode; and update the terminal multi-mode if the terminal configuration fails to match the terminal multi-mode. The terminal configuration failing to match the terminal multi-mode includes that the terminal does not support a service provided by one or more network standards in the terminal multi-mode, and/or the terminal currently supports a service provided by a third network standard and the third network standard has a higher priority than each network standard in the terminal multi-mode.

In combination with the second aspect, in a feasible implementation, the terminal configuration failing to match the terminal multi-mode includes that the terminal does not support the service provided by one or more network standards in the terminal multi-mode, and that the processing module is configured to update the terminal multi-mode according to a result of the comparing includes removing the one or more network standards from the terminal multi-mode.

In combination with the second aspect, in a feasible implementation, the terminal configuration failing to match the terminal multi-mode includes that the terminal currently supports the service provided by the third network standard, and updating the terminal multi-mode according to a result of the comparing includes adding the third network standard into the terminal multi-mode.

In a second aspect of implementations of the disclosure, a terminal including a processor and a memory is provided. The memory stores computer programs, the computer programs include program instructions, and the processor is configured to invoke the program instructions to perform the method of the first aspect.

In a third aspect of implementations of the disclosure, a non-transitory computer readable storage medium is provided. The computer readable storage medium stores computer programs, and the computer programs include program instructions which, when executed by a processor, being operable with the processor to perform the method of the first aspect.

### BRIEF DESCRIPTION OF THE DRAWINGS

FIG. 1 is a schematic flow chart of a method for network access control provided in implementations of the disclosure.

FIG. 2 is a schematic flow chart of another method for network access control provided in implementations of the disclosure.

FIG. 3 is a structural diagram of an apparatus for network access control provided in implementations of the disclosure.

FIG. 4 is a structural diagram of a terminal provided in implementations of the disclosure.

FIG. 5 is a structural diagram of a module device provided in implementations of the disclosure.

### DETAILED DESCRIPTION

Implementations of the disclosure will be described in detail below with reference to the drawings in implementations of the disclosure.

A method for network access control is provided herein. After a terminal fails to access a first target network under a first network standard after powered on, or after the terminal fails to perform cell handover, the terminal has to select a new network to camp on for data or voice services. The terminal sets a flag for forbidding access to the first network standard for the first target network, determines a second target network and a second network standard, updates a terminal multi-mode according to the second target network and the second network standard, and tries to access the second target network under the second network standard according to the updated terminal multi- mode, as such, the terminal can be prevented from reselecting the first target network under the first network standard and can select a suitable network for access quickly, which can improve efficiency of network access.

In a feasible implementation, when a terminal conducts a high-definition voice service, if the terminal registers in a network with a 5G (first network standard) and the network (the first target network) refuses the registration of the terminal, the terminal needs to re-try other networks supporting 5G, or try other networks capable of satisfying the high-definition voice service. The terminal determines a second target network and a second network standard, if the second target network and the first target network are the same network, and the first network standard (5G) and the second network standard (4G) are different network standards, the terminal removes the 5G network standard from the terminal multi-mode, and tries to access the second target network under the 4G network standard, so that the terminal can conduct a voice service.

It should be noted that, the method for network access control is not only applicable to network access under a 5G network standard, but also applicable to network access under other network standards.

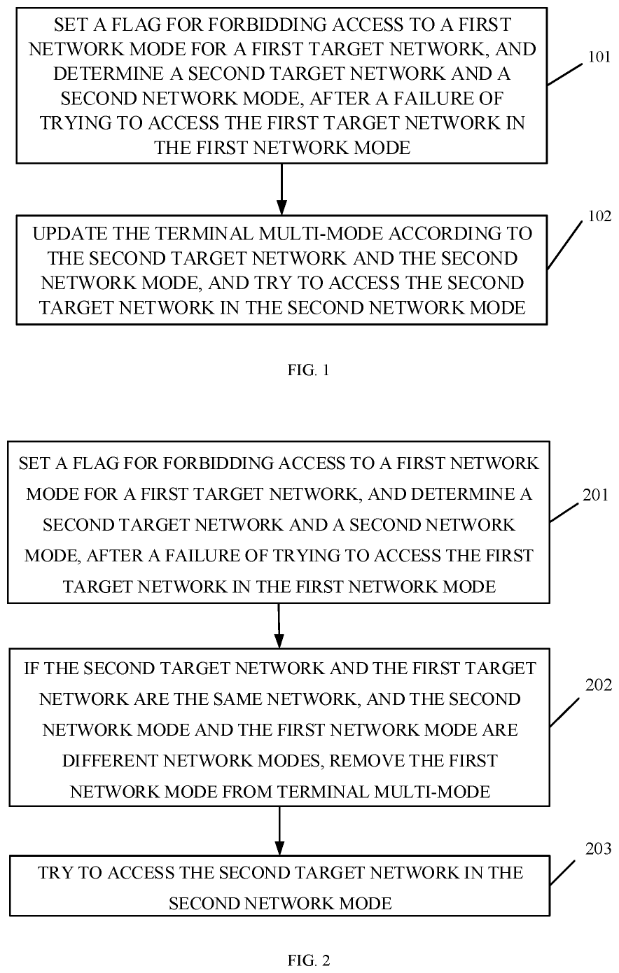

Referring to FIG. 1, which is a schematic flow chart of a method for network access control. The method for network access control provided in this implementation is applicable to a terminal and includes the following.

At 101, set a flag for forbidding access to a first network standard for a first target network, and determine a second target network and a second network standard, after failing to try to access the first target network under the first network standard.

The first network standard and the second network standard are determined according to a terminal multi-mode. The terminal multi-mode indicates network standards that the terminal can access, that is, the terminal multi-mode includes network standards that the terminal can access.

Specifically, because the terminal fails to access the first target network under the first network standard, or the terminal is unable to access successfully for some reasons within a period of time, the terminal fails to try to access the first target network under the first network standard. And after the access fails, the terminal sets the flag for forbidding accessing the first network standard for the first target network, and re-determines the second target network and the second network standard

The first target network and the second target network can be a public land mobile network (PLMN) of an operator. For example, the second target network and the first target network can be the same network, such as the PLMN of China Mobile. The second target network and the first target network can be different networks, for example, the first target network is the PLMN of China Mobile, and the second target network is the PLMN of China Telecom.

The network standards that the terminal can access in the terminal multi-mode may include: 5th generation mobile networks (5G), 4th generation mobile networks (4G), 3th generation mobile networks (3G), 2th generation mobile networks (2G), and any communication standard in future mobile communication technologies. 4G for example includes long term evolution (LTE), 3G for example includes wideband code division multiple access (WCDMA), 2G for example includes global system for mobile communications (GSM).

In a feasible implementation, if the terminal fails to access the first target network under the first network standard, the terminal sets a flag for forbidding access to the first network standard for the first target network, as such, the terminal can be prevented from reselecting the first network standard of the first target network.

It should be noted that, if the terminal fails to access a certain network under a certain network standard, the terminal sets a flag for forbidding access to the certain network standard for the certain network, as such, the terminal can be prevented from reselecting the certain network under the certain standard.

In a feasible implementation, the terminal determines the second target network according to priority of candidate networks, i.e., each of the candidate networks has the corresponding priority and the terminal can determine the second target network according to the priority of the candidate networks. The candidate networks may include the first target network. The priority of the candidate networks may be pre-configured or dynamically determined by the terminal according to current channel conditions, size of reference signal, etc.

If the terminal fails to access the first target network under the first network standard, it is considered that access to the first target network under the first network standard is currently forbidden or access to the first target network under the first network standard is forbidden within a short time. Since access to the first target network is allowable under other network standards, the first target network is taken into consideration when determining the second target network.

For example, the terminal fails to access the first target network under the first network standard, and determines candidate networks, where the candidate networks include the first target network, and set a corresponding priority for each candidate network. The terminal determines the second target network according to the priority of each network; and if the first target network has the highest priority in the candidate networks, the terminal determines the first target network to be the second target network.

Still another example, the terminal fails to access the first target network under the first network standard, and determines candidate networks, where the candidate networks include the first target network, and acquires priority of each candidate network according to a current reference signal. The terminal determines the second target network according to the priority of each network; and if a network (not the first target network) has the highest priority in the candidate networks, the terminal determines the network to be the second target network.

In a feasible implementation, before trying to access the first target network under the first network standard (for example, when the terminal is powered on), the terminal may compare terminal configuration with the terminal multi-mode, and if the terminal configuration does not match the terminal multi-mode, the terminal multi-mode will be updated. There are three cases where the terminal configuration does not match the terminal multi-mode: (1) the terminal currently does not support a service provided by one or more network standards in the terminal multi-mode; (2) the terminal currently supports a service provided by a third network standard, where the third network standard has a higher priority than each network standard in the terminal multi-mode; (3) the terminal currently does not support the service provided by one or more network standards in the terminal multi-mode, and the terminal currently supports the service provided by the third network standard, where the third network standard has the higher priority than each network standard in the terminal multi-mode. The service may be a voice service, a data service, or the like.

In a feasible embodiment, for the foregoing case (1), if the terminal currently does not support the service provided by one or more network standards in the terminal multi-mode, then the one or more network standards are removed from the terminal multi-mode, and modules such as an access layer is notified of the terminal multi-mode with the one or more network standards removed. Subsequently, the terminal performs network selection, registration, measurement and capability reporting according to the terminal multi-mode with the one or more network standards removed. For example, the terminal requires to give priority to voice, and if the 5G high-definition voice is turned off in the terminal configuration, and the terminal multi-mode of the terminal includes a 5G network standard, that is, the terminal currently does not support a voice service provided by the 5G network standard in the terminal multi-mode, the terminal removes the 5G network standard from the terminal multi-mode, and modules such as the access layer is notified with the updated terminal multi-mode.

In another feasible implementation, for the foregoing case (2), the terminal currently supports the service provided by the third network standard, and the third network standard has a higher priority than each network standard in the terminal multi-mode. The terminal adds the third network standard into the terminal multi-mode, and updates the multi-mode with the third network standard added to modules such as the access layer. In this way, subsequently, the terminal performs network selection, registration, and capability reporting again according to the new multi-mode. The priority of each network standard is specified in advance, for example, a network standard having the highest priority in next generation network covered future technologies, has a higher priority than the 5G network standard, and the 5G network standard has a higher priority than the 4G network standard, and so on.

For example, the terminal currently supports the service provided by the 5G network standard, and if each network standard (such as 4G, 3G) in the terminal multi-mode has a lower priority than 5G, then the terminal adds the 5G network standard to the terminal multi-mode, and modules such as the access layer is notified with the updated terminal multi-mode.

It should be noted that, with regard to the foregoing case (3), technical solution thereof can be achieved by combining technical solutions of the foregoing case (1) and the forgoing case (2).

At 102, update the terminal multi-mode according to the second target network and the second network standard, and try to access the second target network under the second network standard.

Specifically, the terminal can update the terminal multi-mode according to the second target network and the second network standard as follows: remove the first network standard from the terminal multi-mode according to the second target network and the second network standard; or keep the terminal multi-mode unchanged according to the second target network and the second network standard.

It should be noted that, details about updating the terminal multi-mode according to the second target network and the second network standard as well as trying to access the second target network under the second network standard are illustrated in FIG. 2, which illustrates the method for network access control.

In implementations of the disclosure, if the terminal fails to try to access the first target network under the first network standard, by setting a flag for forbidding access to the first network standard for the first target network, the terminal can be prevented from reselect the first network standard of the first target network, and the efficiency of network access can be improved.

Referring to FIG. 2, which is a schematic flowchart of another method for network access control according to implementations of the disclosure. The method for network access control is applied to a terminal and includes the following.

At 201, set a flag for forbidding access to a first network standard for a first target network, and determine a second target network and a second network standard, after failing to try to access the first target network under the first network standard.

At 202, if the second target network and the first target network are the same network, and the second network standard and the first network standard are different network standards, remove the first network standard from terminal multi-mode.

Specifically, a network generally supports various network standards, if the second target network and the first target network are the same network, and the second network standard and the first network standard are different network standards, the terminal removes the first network standard from the terminal multi-mode. According to the terminal multi-mode with the first network standard removed, the terminal can access the second network standard. For example, after failing to try to access the first target network under the 5G network standard, the terminal determines the second target network to be the first target network, and the second network standard is the 4G network standard, then the terminal removes the 5G network standard from the terminal multi-mode.

When the second target network and the first target network are the same network, and the second network standard and the first network standard are different network standards, the second network standard has a lower priority than the first network standard. It should be noted that, the priority of the 5G, 4G, 3G and 2G network standards decreases successively.

Furthermore, after removing the first network standard (for example, 5G) from the terminal multi-mode, the terminal notifies modules such as the access layer of the terminal multi-mode with the first network standard removed, to prevent a module such as the access layer from measuring subsequently a network which supports the first network standard or prevent the terminal from reselecting a cell under the first network standard. Capability under the first network standard will not be reported in capability reporting interacted with the network. Modules such as the access layer are internal modules of the terminal.

In a feasible implementation, if the second target network and the first target network are different networks, the terminal keeps the terminal multi-mode unchanged. In this case, the second network standard and the first network standard can be the same network standard, or the second network standard can have a higher priority or lower priority than the first network standard. For example, when the first network standard is the 4G network standard, the second network standard can be the 4G network standard, or can be the 3G network standard or 5G network standard.

At 203, try to access the second target network under the second network standard.

In a feasible implementation, when failing to access the first target network under the first network standard, the terminal acquires a first duration in which the flag for forbidding access to the first network standard is set for the first target network. Remove the flag for forbidding access to the first network standard for the first target network, if the first duration is greater than a duration threshold when accessing the second target network under the second network standard successfully.

Alternatively, when failing to access the first target network under the first network standard, set a timer for the flag for forbidding access to the first network standard for the first target network. The terminal can re-try to access the first target network when the timer expires. After the first network standard is removed from the terminal multi-mode, if the timer for the flag has expired when accessing the second target network under the first network standard successfully, remove the flag for forbidding access to the first network standard for the first target network.

If the second target network is configured to be forbidden from accessing the first network standard, that is, the second target network and the first target network are the same network, in one feasible implementation, after the flag for forbidding access to the first network standard for the first target network is removed, the terminal adds/restores the first network standard back to/in the terminal multi-mode, and notifies modules such as the access layer of the updated multi-mode. Subsequently, modules such as the access layer perform measurement on the network according to the updated multi-mode, such measurement includes measurements on network signal, network quality, and the like. After the access layer module performs measurement on the first target network, if the measurement result satisfies a camp condition (such as S criteria), the terminal tries to access the first target network under the first network standard, which can reduce the overhead of the access procedure.

If the second target network is configured to be forbidden from accessing the first network standard, that is, the second target network and the first target network are the same network, in another feasible implementation, after removing the flag for forbidding access to the first network standard for the first target network, the terminal restores the first network standard to the terminal multi-mode, and notifies modules such as the access layer of the updated terminal multi-mode. Network selection procedure regarding the first target network under the first network standard is triggered directly. As such, the terminal can try to access the first target network under the first network standard quickly.

For example, if the second target network is configured to be forbidden from accessing the first network standard, that is, the second target network and the first target network are the same network, after the 5G network standard is removed from the terminal multi-mode, if the terminal accesses the LTE network standard (that is, the second network standard) successfully in the second target network, and if a duration, in which access to the 5G network standard (that is, the first network standard) in the first target network is forbidden, is greater than one hour, remove the flag set for the first target network for forbidding access to the 5G network standard. After the flag set for the first target network for forbidding access to the 5G network standard is removed, there are two options.

(1) After the 5G network standard is restored back to the terminal multi-mode and modules such as the access layer is notified with the updated terminal multi-mode, subsequently, modules such as the access layer can perform measurement on the first target network for which the flag for forbidding access to 5G has been removed. If the measurement result of the first target network satisfy a cell reselection condition, the terminal can try to access the first target network under the 5G network standard.

(2) After the 5G network standard is restored back to the terminal multi-mode and modules such as the access layer is notified with the updated terminal multi-mode, a network selection procedure of searching for a first target network under a 5G network standard is triggered directly, that is, try to access the first target network under the 5G network standard.

If the second target network is not configured to be forbidden from accessing the first network standard, that is, the second target network and the first target network are different networks, in a feasible implementation, the terminal obtains a first duration in which the flag for forbidding access to the first network standard is set for the first target network. The terminal removes the flag for forbidding access to the first network standard for the first target network and compares the priority of the first target network with the priority of the second target network, if the first duration is greater than a duration threshold when accessing the second target network under the second network standard successfully. The terminal keeps to access the second target network if the second target network has a higher priority than the first target network. The terminal tries to access the first target network under the first network standard if the second target network has a lower priority than the first target network.

For example, when the terminal accesses the 5G network standard (that is, the second network standard) in the second target network (that is, PLMN which is not forbidden to access 5G), the terminal obtains a first duration in which the flag for forbidding access to the 5G network standard (that is, the first network standard) is set for the first target network (that is, PLMN which is forbidden to access 5G). If the first duration is greater than the duration threshold, the flag for forbidding access to the 5G network standard for the first target network is removed. Then the terminal compares the priority of the first target network and the priority of the second target network, if the priority of the second target network is higher than the priority of the first target network, the terminal keeps access to the second target network, and if the priority of the second target network is lower than the priority of the first target network, the terminal tries to access the first target network under the 5G network standard.

In a feasible implementation, if the terminal fails to access the second network standard in the second target network, the terminal can set a flag for forbidding access to the second network standard for the second target network, and determines a third target network and a fourth network standard. The terminal updates the terminal multi-mode according to the third target network and the fourth network standard, and tries to access the third target network under the fourth network standard.

As can be seen, when failing to access the second network standard in the second target network, the second target network and the second network standard become a new first target network and a new first network standard, and the third target network and the fourth network standard determined become a new second target network and a new network standard. For details about updating the terminal multi-mode according to the third target network and the fourth network standard and trying to access the third target network under the fourth network standard, reference can be made to updating the terminal multi-mode according to the second target network and the second network standard and trying to access the second target network under the second network standard. For example, when the third target network and the second target network are the same network and the fourth network standard and the second network standard are different network standards, the second network standard will be removed from the terminal multi-mode.

It should be noted that, for a multi-mode terminal, the terminal will try to access a network in turn according to a descending order of priority of network standards. If the network is not successfully accessed under all network standards, the multi-mode terminal will retry to access the network in turn according to the descending order of priority of the network standards.

For example, for a 5G multi-mode terminal, it will try to access a network under 5G network standard. If the terminal fails to access the network under the 5G network standard and removes the 5G network standard from terminal multi-mode, the terminal will try to access the network under 4G network standard. If the terminal fails to access the network under the 4G network standard and removes the 4G network standard from terminal multi-mode, the terminal will try to access the network under 3G network standard. If the terminal fails to access the network under the 4G network standard and removes the 4G network standard from terminal multi-mode, the terminal will try to access the network under 3G network standard. If the terminal fails to access the network under the 3G network standard and removes the 3G network standard from terminal multi-mode, the terminal will try to access the network under 2G network standard. If the terminal fails to access the network under the 2G network standard, the terminal will retry to access the network under the 5G network standard.

In a feasible implementation, after the terminal accesses the second target network under the second network standard successfully, the terminal will receive an equivalent-network identifier (ID) set from the second target network, where the ID of the first target network is in the equivalent- network ID set. When updating the equivalent-network ID set for the first network standard, the terminal removes the ID of the first target network from the equivalent-network ID set. That is, when the second target network is accessed successfully under the second network standard, the equivalent-network ID set received by the terminal from the second target network includes the ID of the first target network. If the terminal determines according to network information locally stored that the terminal is currently forbidden from accessing the first network standard, the terminal will remove the ID of the first target network from the equivalent-network ID set when updating the equivalent-network ID set for the first network standard. As such, the terminal can be prevented from reselecting a first-network-standard cell in the first target network which is forbidden from accessing the first network standard. The network information includes the flag for forbidding the first target network to access the first network standard.

In a feasible implementation, after the terminal accesses the second target network under the second network standard successfully, the terminal will receive an equivalent-network identifier (ID) set from the second target network, where the equivalent-network ID set includes the ID of the first target network. The terminal will retain the ID of the first target network when updating the equivalent-network identifier (ID) set for a non-first network standard, therefore, reselection to a non first-network-standard cell in the first target network which is forbidden from accessing the first network standard is still allowed. For example, when the terminal accesses the second target network under the 5G network standard, the terminal receives an equivalent-network ID list from the second target network, where the ID of the first target network is in the equivalent-network ID list. If network information stored locally at the terminal includes a flag for forbidding the first target network to access the 5G network standard, the terminal will remove the ID of the first target network from the equivalent-network ID list when updating the equivalent-network ID list for the 5G network standard, so as to prevent the terminal from reselecting a 5G cell in the first target network which is forbidden from accessing the 5G network standard; on the other hand, the terminal will not remove the ID of the first target network from the equivalent-network ID list when updating the equivalent-network ID list for 2G, 3G, 4G, and 5G network standards, therefore, reselection to a non 5G-network-mode cell in the first target network which is forbidden from accessing the 5G network standard is still allowed.

The “equivalent network” mentioned herein refers to a network has the same priority with the second target network. The terminal can preferentially reselect equivalent network when the second target network is unavailable or for other reasons.

It should be noted that, the “equivalent network ID” mentioned herein is for indicating a certain equivalent network. The “flag” for forbidding the first target network to access the first network standard refers to that the first target network is currently forbidden to access the first network standard.

In a feasible implementation, when a terminal, which previously camps on a network which is not forbidden to access a certain network standard, camps on a network which is forbidden to access the certain network standard, and the terminal multi-mode includes the certain network standard, the terminal will remove the certain network standard from the terminal multi-mode, so as to prevent a cell of the network which is forbidden to access the certain network standard from measuring the certain network standard and reselecting the network standard, and prevent the terminal from reporting the capability corresponding to the certain network standard to the network.

For example, when a terminal, which previously camps on PLMN which is not forbidden to access 5G (can be comprehended as a network which supports 5G network standard), camps on non-5G network standard of PLMN which is forbidden to access 5G (can be comprehended as a network which does not support 5G network standard), the terminal can remove the 5G network standard from the terminal multi-mode, and notifies modules such as the access layer of the terminal multi-mode with the 5G network standard removed, so as to avoid 5G measurement on PLMN which is forbidden to access 5G and 5G reselection.

In a feasible implementation, after accessing the second target network successfully under the second network standard, subsequently, the terminal can perform measurement on a network which is not forbidden to access the second network standard or reselect another network which is not forbidden to access the second network standard, and capability of the second network standard is reported when reporting capability to the network. For example, when the terminal accesses 5G PLMN under 5G network standard, subsequently, the terminal can perform measurement on a network which is not forbidden to access 5G network standard, report the capability of the 5G network standard to the network, and reselect a cell under the 5G network standard once a reselection condition is met.

In a feasible implementation, after the terminal accesses the second target network successfully under a network standard other than the second network standard and removes the second network standard from the terminal multi-mode, the terminal subsequently does not have to measure the network under the second network standard and does not have to report the capability of the second network standard.

For example, if the terminal accesses the second target network successfully under the 4G network standard (the second network standard is 5G network standard), and removes the 5G network standard from the terminal multi-mode, the terminal subsequently does not have to measure the network which is not forbidden to access the 5G network standard and does not have to report the capability of the 5G network standard.

In some implementations, updating the terminal multi-mode according to the second target network and the second network standard specifically includes removing the first network standard from the terminal multi-mode if the second target network is the same as the first target network and the second network standard is different from the first network standard.

In some implementations, after successful access to the second target network under the second network standard, the method further includes: receiving an equivalent-network identifier (ID) set from the second target network, where an ID of the first target network belongs to the equivalent-network ID set; and removing the ID of the first target network from the equivalent- network ID set, when updating the equivalent-network ID set for the first network standard.

In some implementations, the second target network is configured to be forbidden from accessing the first network standard, and the method further includes: obtaining a first duration in which the flag for forbidding access to the first network standard is set for the first target network; and removing the flag for forbidding access to the first network standard for the first target network, and restoring the first network standard back to the terminal multi-mode, if the first duration is greater than a duration threshold when accessing the second target network under the second network standard successfully.

In some implementations, after restoring the first network standard back to the terminal multi- mode, the method further includes trying to access the first target network under the first network standard.

In some implementations, the second target network is not configured to be forbidden from accessing the first network standard, and the method further includes obtaining the first duration in which the flag for forbidding access to the first network standard is set for the first target network; removing the flag for forbidding access to the first network standard for the first target network, if the first duration is greater than the duration threshold when accessing the second target network under the second network standard successfully; and trying to access the first network standard in the first target network, if the second target network has a lower priority than the first target network.

In some implementations, before trying to access the first target network under the first network standard, the method further includes comparing terminal configuration with the terminal multi-mode; and updating the terminal multi-mode if the terminal configuration fails to match the terminal multi-mode. The terminal configuration failing to match the terminal multi-mode includes that the terminal does not support a service provided by one or more network standards in the terminal multi-mode, and/or the terminal currently supports a service provided by a third network standard and the third network standard has a higher priority than each network standard in the terminal multi-mode.

In some implementations, the terminal configuration failing to match the terminal multi-mode includes that the terminal does not support the service provided by one or more network standards in the terminal multi-mode, and updating the terminal multi-mode according to a result of the comparing specifically includes removing the one or more network standards from the terminal multi-mode.

In some implementations, the terminal configuration failing to match the terminal multi-mode includes that the terminal currently supports the service provided by the third network standard, and updating the terminal multi-mode according to a result of the comparing specifically includes adding the third network standard into the terminal multi-mode.

In some implementations, an apparatus for network access control is provided and includes a determining module and a processing module. The determining module is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access. The processing module is configured to update the terminal multi-mode according to the second target network and the second network standard, and try to access the second target network under the second network standard.

In some implementations, the processing module is configured to remove the first network standard from the terminal multi-mode if the second target network is the same as the first target network and the second network standard is different from the first network standard.

In some implementations, after successful access to the second target network under the second network standard, the apparatus further includes a receiving module. The receiving module is configured to receive an equivalent-network identifier (ID) set from the second target network, where an ID of the first target network belongs to the equivalent-network ID set. The processing module is further configured to remove the ID of the first target network from the equivalent- network ID set, when updating the equivalent-network ID set for the first network standard.

In some implementations, the second target network is configured to be forbidden from accessing the first network standard, and the processing module is further configured to obtain a first duration in which the flag for forbidding access to the first network standard is set for the first target network. Additionally, the processing module 302 is further configured to remove the flag for forbidding access to the first network standard for the first target network, and restore the first network standard back to the terminal multi-mode, if the first duration is greater than a duration threshold when accessing the second target network under the second network standard successfully.

In some implementations, the processing module is further configured to try to access the first target network under the first network standard after restoring the target standard back to the terminal multi-mode.

In some implementations, the second target network is not configured to be forbidden from accessing the first network standard, and the processing module is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In some implementations, before trying to access the first target network under the first network standard, the processing module is further configured to compare terminal configuration with the terminal multi-mode; and update the terminal multi-mode if the terminal configuration fails to match the terminal multi-mode. The terminal configuration failing to match the terminal multi-mode includes that the terminal does not support a service provided by one or more network standards in the terminal multi-mode, and/or the terminal currently supports a service provided by a third network standard and the third network standard has a higher priority than each network standard in the terminal multi-mode.

In some implementations, the terminal configuration failing to match the terminal multi-mode includes that the terminal does not support the service provided by one or more network standards in the terminal multi-mode, and that the processing module is configured to update the terminal multi-mode according to a result of the comparing includes removing the one or more network standards from the terminal multi-mode.

In some implementations, the terminal configuration failing to match the terminal multi- mode includes that the terminal currently supports the service provided by the third network standard, and updating the terminal multi-mode according to a result of the comparing includes adding the third network standard into the terminal multi-mode.

In implementations of the disclosure, the terminal sets the flag for forbidding access to the first network standard for the first target network, and determines the second target network and the second network standard, after failing to try to access the first target network under the first network standard. If the second target network and the first target network are the same network, and the second network standard and the first network standard are different network standards, the terminal removes the first network standard from terminal multi-mode and tries to access the second target network under the second network standard. As such, the terminal can be prevented from reselect the first network standard of the first target network and access the second target network quickly under the second network standard to select a suitable network for access quickly, which can improve efficiency of network access.

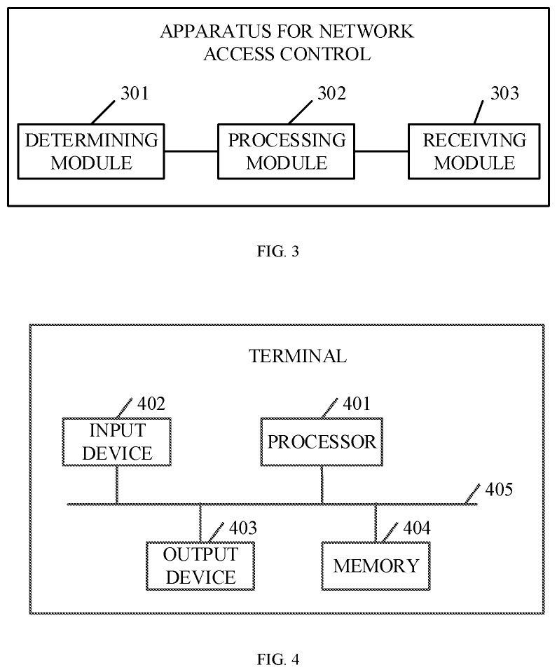

Referring to FIG. 3, which is structural diagram of an apparatus for network access control provided in implementations of the disclosure. The apparatus is applicable to a terminal and includes a determining module 301 and a processing module 302.

The determining module 301 is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access.

The processing module 302 is configured to update the terminal multi-mode according to the second target network and the second network standard, and try to access the second target network under the second network standard.

In a feasible implementation, the processing module 302 is specifically configured to remove the first network standard from the terminal multi-mode if the second target network is the same as the first target network and the second network standard is different from the first network standard.

In a feasible implementation, after successful access to the second target network under the second network standard, the apparatus further includes a receiving module 303. The receiving module 303 is configured to receive an equivalent-network identifier (ID) set from the second target network, where an ID of the first target network belongs to the equivalent-network ID set. The processing module 302 is further configured to remove the ID of the first target network from the equivalent-network ID set, when updating the equivalent-network ID set for the first network standard.

In a feasible implementation, the second target network is configured to be forbidden from accessing the first network standard, and the processing module 302 is further configured to obtain a first duration in which the flag for forbidding access to the first network standard is set for the first target network. Additionally, the processing module 302 is further configured to remove the flag for forbidding access to the first network standard for the first target network, and restore the first network standard back to the terminal multi-mode, if the first duration is greater than a duration threshold when accessing the second target network under the second network standard successfully.

In a feasible implementation, the processing module 302 is further configured to try to access the first target network under the first network standard after restoring the target standard back to the terminal multi-mode.

In a feasible implementation, the second target network is not configured to be forbidden from accessing the first network standard, and the processing module 302 is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In a feasible implementation, before trying to access the first network under the first network standard, the processing module 302 is further configured to compare terminal configuration with the terminal multi-mode; and update the terminal multi-mode if the terminal configuration fails to match the terminal multi-mode. The terminal configuration failing to match the terminal multi- mode includes that the terminal does not support a service provided by one or more network standards in the terminal multi-mode, and/or the terminal currently supports a service provided by a third network standard and the third network standard has a higher priority than each network standard in the terminal multi-mode.

In a feasible implementation, the terminal configuration failing to match the terminal multi- mode includes that the terminal does not support the service provided by one or more network standards in the terminal multi-mode, and the processing module 302 is specifically configured to remove the one or more network standards from the terminal multi-mode.

In a feasible implementation, the terminal configuration failing to match the terminal multi- mode includes that the terminal currently supports the service provided by the third network standard, and the processing module 302 is specifically configured to add the third network standard into the terminal multi-mode.

It could be understood that functions of each functional module of the apparatus for network access control in the implementation can be specifically implemented with the methods in the above method implementations. The specific implementation process can refer to the relevant illustration of the above method implementations, and will not be repeated here.

The apparatus for network access control may be a chip or a chip module. Each module included in each apparatus and product described in the above implementations can be a software module or a hardware module, or be a software module partially or a hardware module partially. For example, for each apparatus and product applied to or integrated into the chip, each module contained therein can be implemented by means of hardware such as circuit; or at least some modules can be implemented by means of software program, which runs on the processor integrated inside the chip, and the remaining (if any) modules can be implemented by means of hardware such as circuit. For each apparatus and product applied to or integrated into the chip module, each module contained therein can be implemented by means of hardware such as circuit, and different modules can be located in the same component (such as a chip, a circuit module, etc.) or in different components of the chip module; or at least some modules can be implemented by means of software program, which runs on the processor integrated inside the chip module, and the remaining (if any) modules can be implemented by means of hardware such as circuit. For each apparatus and product applied to or integrated into a terminal, each module contained therein can be implemented by means of hardware such as circuit, and different modules can be located in the same component (such as a chip, a circuit module, etc.) or in different components of the terminal; or at least some modules can be implemented by means of software program, which runs on the processor integrated inside the terminal, and the remaining (if any) modules can be implemented by means of hardware such as circuit.

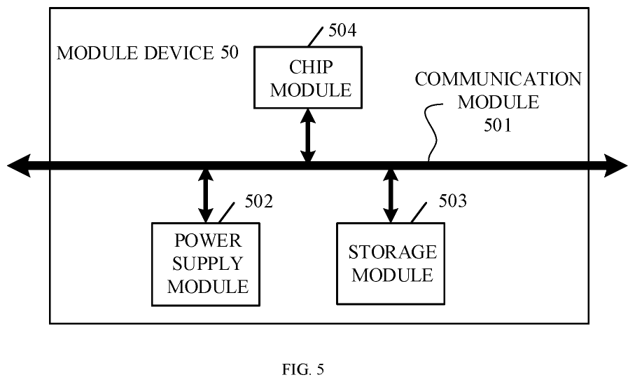

Referring to FIG. 4, which is a structural diagram of a terminal provided in implementations of the disclosure. The terminal provided in implementations of the disclosure illustrated in FIG. 4 may include a processor 401, an input device 402, an output device 403, and a memory 404. The processor 401, the input device 402, the output device 403, and the memory 404 are connected via a bus 405. The memory 404 is used to store computer programs, which include program instructions, and the processor 401 is used to execute program instructions stored in the memory 404. The input device 402 and the output device 403 can be collectively referred to as a transceiver.

In implementations of the disclosure, the processor 401 executes the following operations by running the executable program code in the memory 404. The processor 401 is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access; and update the terminal multi-mode according to the second target network and the second network standard, and try to access the second target network under the second network standard.

In a feasible implementation, the processor 401 updates the terminal multi-mode according to the second target network and the second network standard as follows. The processor 401 is configured to remove the first network standard from the terminal multi-mode if the second target network is the same as the first target network and the second network standard is different from the first network standard.

In a feasible implementation, after successful access to the second target network under the second network standard, the processor 401 is further configured to receive an equivalent-network identifier (ID) set from the second target network, where an ID of the first target network belongs to the equivalent-network ID set; and remove the ID of the first target network from the equivalent- network ID set, when updating the equivalent-network ID set for the first network standard.

In a feasible implementation, the second target network is configured to be forbidden from accessing the first network standard, and the processor 401 is further configured to obtain a first duration in which the flag for forbidding access to the first network standard is set for the first target network; remove the flag for forbidding access to the first network standard for the first target network, and restore the first network standard back to the terminal multi-mode, if the first duration is greater than a duration threshold when accessing the second target network under the second network standard successfully.

In a feasible implementation, the processor 401 is further configured to try to access the first target network under the first network standard after restoring the first network standard back to the terminal multi-mode.

In a feasible implementation, the second target network is not configured to be forbidden from accessing the first network standard, and the processor 401 is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In a feasible implementation, before trying to access the first target network under the first network standard, the processor 401 is further configured to compare terminal configuration with the terminal multi-mode; and update the terminal multi-mode if the terminal configuration fails to match the terminal multi-mode. The terminal configuration failing to match the terminal multi- mode includes that the terminal does not support a service provided by one or more network standards in the terminal multi-mode, and/or the terminal currently supports a service provided by a third network standard and the third network standard has a higher priority than each network standard in the terminal multi-mode.

In a feasible implementation, the terminal configuration failing to match the terminal multi- mode includes that the terminal does not support the service provided by one or more network standards in the terminal multi-mode, and the processor 401 is specifically configured to update the terminal multi-mode according to a result of the comparing as follows. The processor 401 is configured to remove the one or more network standards from the terminal multi-mode.

In a feasible implementation, the terminal configuration failing to match the terminal multi- mode includes that the terminal currently supports the service provided by the third network standard, and the processor 401 is configured to updates the terminal multi-mode according to a result of the comparing as follows. The processor 401 is configured to add the third network standard into the terminal multi-mode.

It should be understood that, in implementations of the disclosure, the processor 401 may be a central processing unit (CPU), a general-purpose processor, a digital signal processor (DSP), an application specific integrated circuit (ASIC), a field-programmable gate array (FPGA), or other programmable logic devices, discrete gates or transistor logic devices, discrete hardware components. The general-purpose processor may be a microprocessor or the processor may also be any conventional processor or the like.

The memory 404 may be a read-only memory or a random access memory and provides instructions and data to the processor 401. Part of the memory 404 may also be a non-volatile random access memory.

The input device 402 may include a keyboard, touch mode input, etc., and input data information to the processor 401. The output device 403 may include a display or the like.

Specifically, the processor 401, the input device 402, the output device 403, and the memory 404 herein can implement the implementation method described in the flow of a method for network access control provided by implementations of the disclosure, and can also implement the implementation method described in a device for network access control provided by implementations of the disclosure, which will not be repeated here.

Correspondingly, a chip is provided in implementations of the disclosure. The chip is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access. In addition, the chip is configured to update the terminal multi-mode according to the second target network and the second network standard, and try to access the second target network under the second network standard.

In a feasible implementation, when updating the terminal multi-mode according to the second target network and the second network standard, the chip is specifically configured to remove the first network standard from the terminal multi-mode if the second target network is the same as the first target network and the second network standard is different from the first network standard.

In a feasible implementation, after successful access to the second target network under the second network standard, the chip is further configured to receive an equivalent-network identifier (ID) set from the second target network, where an ID of the first target network belongs to the equivalent-network ID set; and remove the ID of the first target network from the equivalent- network ID set, when updating the equivalent-network ID set for the first network standard.

In a feasible implementation, the second target network is configured to be forbidden from accessing the first network standard, and the chip is further configured to obtain a first duration in which the flag for forbidding access to the first network standard is set for the first target network; and remove the flag for forbidding access to the first network standard for the first target network, and restore the first network standard back to the terminal multi-mode, if the first duration is greater than a duration threshold when accessing the second target network under the second network standard successfully.

In a feasible implementation, after restoring the first network standard back to the terminal multi-mode, the chip is further configured to try to access the first target network under the first network standard.

In a feasible implementation, the second target network is not configured to be forbidden from accessing the first network standard, and the chip is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In a feasible implementation, before trying to access the first target network under the first network standard, the chip is further configured to compare terminal configuration with the terminal multi-mode; and update the terminal multi-mode if the terminal configuration fails to match the terminal multi-mode. The terminal configuration failing to match the terminal multi- mode includes that the terminal does not support a service provided by one or more network standards in the terminal multi-mode, and/or the terminal currently supports a service provided by a third network standard and the third network standard has a higher priority than each network standard in the terminal multi-mode.

In a feasible implementation, the terminal configuration failing to match the terminal multi- mode includes that the terminal does not support the service provided by one or more network standards in the terminal multi-mode. The chip is configured to update the terminal multi-mode according to a result of the comparing, where the chip is specifically configured to remove the one or more network standards from the terminal multi-mode.

In a feasible implementation, the terminal configuration failing to match the terminal multi- mode includes that the terminal currently supports the service provided by the third network standard. The chip is configured to updates the terminal multi-mode according to a result of the comparing, where the chip is specifically configured to add the third network standard into the terminal multi-mode.

Correspondingly, as illustrated in FIG. 5, FIG. 5 is a structural diagram of a module device provided in implementations of the disclosure. The module device 50 includes a communication module 501, a power supply module 502, a storage module 503, and a chip module 504.

The power supply module 502 is configured to supply power for the module device. The storage module 503 is configured to store data and instructions. The communication module 501 is configured for internal communication of the module device or for communication between the module device and an external device. The chip module 504 is configured to set a flag for forbidding access to a first network standard for a first target network, and determine a second target network and a second network standard, after failing to try to access the first target network under the first network standard, where the first network standard and the second network standard are determined according to a terminal multi-mode, and the terminal multi-mode indicates network standards that the terminal can access; and update the terminal multi-mode according to the second target network and the second network standard, and try to access the second target network under the second network standard.

In a feasible implementation, when updating the terminal multi-mode according to the second target network and the second network standard, the chip module 504 is specifically configured to remove the first network standard from the terminal multi-mode if the second target network is the same as the first target network and the second network standard is different from the first network standard.

In a feasible implementation, after successful access to the second target network under the second network standard, the chip module 504 is further configured to receive an equivalent- network identifier (ID) set from the second target network, where an ID of the first target network belongs to the equivalent-network ID set; and remove the ID of the first target network from the equivalent-network ID set, when updating the equivalent-network ID set for the first network standard.

In a feasible implementation, the second target network is configured to be forbidden from accessing the first network standard, and the chip module 504 is further configured to obtain a first duration in which the flag for forbidding access to the first network standard is set for the first target network; and remove the flag for forbidding access to the first network standard for the first target network, and restore the first network standard back to the terminal multi-mode, if the first duration is greater than a duration threshold when accessing the second target network under the second network standard successfully.

In a feasible implementation, after restoring the first network standard back to the terminal multi-mode, the chip module 504 is further configured to try to access the first target network under the first network standard.

In a feasible implementation, the second target network is not configured to be forbidden from accessing the first network standard, and the chip module 504 is further configured to obtain the first duration in which the flag for forbidding access to the first network standard is set for the first target network; remove the flag for forbidding access to the first network standard for the first target network, if the first duration is greater than the duration threshold when accessing the second target network under the second network standard successfully; and try to access the first target network under the first network standard, if the second target network has a lower priority than the first target network.

In a feasible implementation, before trying to access the first target network under the first network standard, the chip module 504 is further configured to compare terminal configuration with the terminal multi-mode; and update the terminal multi-mode if the terminal configuration fails to match the terminal multi-mode. The terminal configuration failing to match the terminal multi-mode includes that the terminal does not support a service provided by one or more network standards in the terminal multi-mode, and/or the terminal currently supports a service provided by a third network standard and the third network standard has a higher priority than each network standard in the terminal multi-mode.

In a feasible implementation, the terminal configuration failing to match the terminal multi- mode includes that the terminal does not support the service provided by one or more network standards in the terminal multi-mode. When updating the terminal multi-mode according to a result of the comparing, the chip module 504 is specifically configured to remove the one or more network standards from the terminal multi-mode.

In a feasible implementation, the terminal configuration failing to match the terminal multi- mode includes that the terminal currently supports the service provided by the third network standard. When updating the terminal multi-mode according to a result of the comparing, the chip module 504 is specifically configured to add the third network standard into the terminal multi- mode.

For each apparatus and product applied to or integrated into the chip module, each module contained therein can be implemented by means of hardware such as circuit, and different modules can be located in the same component (such as a chip, a circuit module, etc.) or in different components of the chip module; or at least some modules can be implemented by means of software program, which runs on the processor integrated inside the chip module, and the remaining (if any) modules can be implemented by means of hardware such as circuit.

A computer readable storage medium storing computer programs is further provided in implementations of the disclosure. The computer programs include program instructions which, when executed by a processor, can perform the steps of implementations of the network access control.

It will be understood by those of ordinary skill in the art that all or a part of the processes in the methods of the implementations described above may be accomplished by means of a program to instruct associated hardware, and the program may be stored in a computer readable storage medium. When executed, the program can include the flow of the implementations of the above methods. The storage medium may be a magnetic disk, an optical disk, a read-only memory (ROM), or a random access memory (RAM), etc.

The terms “first”, “second”, “third”, and the like used in the specification, the claims, and the accompany drawings of the disclosure are used to distinguish different objects rather than describe a particular order.

The above implementations are only a part implementations of this disclosure, of course, the above implementations cannot be used to limit the scope of this disclosure, the ordinary skill in the field can understand all or a part of the process to realize the above implementations of the disclosure, and the equivalent changes made in accordance with the claims of this disclosure, still belong to the scope of the disclosure covered.

1. A method for network access control, comprising:
setting a flag for forbidding access to a first network standard for a first target network, and determining a second target network and a second network standard, after failing to access the first target network under the first network standard, wherein the first network standard and the second network standard are determined according to a terminal multi-mode, and the terminal multi-mode indicates network standards that the terminal can access; and
updating the terminal multi-mode according to the second target network and the second network standard, and trying to access the second target network under the second network standard.

2. The method of claim 1, wherein updating the terminal multi-mode according to the second target network and the second network standard comprises:
removing the first network standard from the terminal multi-mode in response to the second target network being the same as the first target network and the second network standard being different from the first network standard.

3. The method of claim 1, further comprising:
receiving an equivalent-network identifier (ID) set from the second target network, wherein an ID of the first target network belongs to the equivalent-network ID set; and
removing the ID of the first target network from the equivalent-network ID set, when updating the equivalent-network ID set for the first network standard.

4. The mothed of claim 2, wherein the second target network is configured to be forbidden from accessing the first network standard, and the method further comprises:
obtaining a first duration in which the flag for forbidding access to the first network standard is set for the first target network; and
removing the flag for forbidding access to the first network standard for the first target network, and restoring the first network standard back to the terminal multi-mode, in response to the first duration being greater than a duration threshold when accessing the second target network under the second network standard successfully.

5. The method of claim 4, further comprising:
trying to access the first target network under the first network standard.

6. The method of claim 4, wherein the second target network is not configured to be forbidden from accessing the first network standard, and the method further comprises:
obtaining the first duration in which the flag for forbidding access to the first network standard is set for the first target network;
removing the flag for forbidding access to the first network standard for the first target network, in response to the first duration being greater than the duration threshold when accessing the second target network under the second network standard successfully; and
trying to access the first target network under the first network standard, in response to the second target network having a lower priority than the first target network.

7. The method of claim 1, wherein before trying to access the first target network under the first network standard, the method further comprises:
comparing terminal configuration with the terminal multi-mode; and
updating the terminal multi-mode in response to the terminal configuration failing to match the terminal multi-mode, wherein
the terminal configuration failing to match the terminal multi-mode comprises that the terminal does not support a service provided by one or more network standards in the terminal multi-mode, and/or the terminal currently supports a service provided by a third network standard and the third network standard has a higher priority than each network standard in the terminal multi-mode.

8. The method of claim 7, wherein the terminal configuration failing to match the terminal multi-mode comprises that the terminal does not support the service provided by one or more network standards in the terminal multi-mode, and updating the terminal multi-mode according to a result of the comparing comprises:
removing the one or more network standards from the terminal multi-mode.

9. The method of claim 8, wherein the terminal configuration failing to match the terminal multi-mode comprises that the terminal currently supports the service provided by the third network standard, and updating the terminal multi-mode according to a result of the comparing comprises:
adding the third network standard into the terminal multi-mode.

10-14. (canceled)

15. A terminal comprising:
a processor; and
a memory storing computer programs which, when executed by the processor, are operable with the processor to:
set a flag for forbidding access to a first network standard for a first target network, and determine a second target network and a second network standard, after failing to access the first target network under the first network standard, wherein the first network standard and the second network standard are determined according to a terminal multi-mode, and the terminal multi-mode indicates network standards that the terminal can access; and
update the terminal multi-mode according to the second target network and the second network standard, and try to access the second target network under the second network standard.

16. The terminal of claim 15, wherein the processor is configured to:
remove the first network standard from the terminal multi-mode in response to the second target network being the same as the first target network and the second network standard being different from the first network standard.

17. The terminal of claim 15, further comprising a transceiver, when executed by the processor, the computer programs are operable with the processor to:
cause the transceiver to receive an equivalent-network identifier (ID) set from the second target network, wherein an ID of the first target network belongs to the equivalent- network ID set; and
remove the ID of the first target network from the equivalent-network ID set, when updating the equivalent-network ID set for the first network standard.

18. The terminal of claim 16, wherein the second target network is configured to be forbidden from accessing the first network standard, and the processor is configured to:
obtain a first duration in which the flag for forbidding access to the first network standard is set for the first target network; and
remove the flag for forbidding access to the first network standard for the first target network, and restore the first network standard back to the terminal multi-mode, in response to the first duration being greater than a duration threshold when accessing the second target network under the second network standard successfully.

19. The terminal of claim 18, the processor is configured to:
try to access the first target network under the first network standard.

20. The terminal of claim 18, wherein the second target network is not configured to be forbidden from accessing the first network standard, and the processor is configured to:
obtain the first duration in which the flag for forbidding access to the first network standard is set for the first target network;
remove the flag for forbidding access to the first network standard for the first target network, in response to the first duration being greater than the duration threshold when accessing the second target network under the second network standard successfully; and
try to access the first target network under the first network standard, in response to the second target network having a lower priority than the first target network.

21. The terminal of claim 15, wherein the processor is configured to:
compare terminal configuration with the terminal multi-mode; and
update the terminal multi-mode in response to the terminal configuration failing to match the terminal multi-mode, wherein
the terminal configuration failing to match the terminal multi-mode comprises that the terminal does not support a service provided by one or more network standards in the terminal multi-mode, and/or the terminal currently supports a service provided by a third network standard and the third network standard has a higher priority than each network standard in the terminal multi-mode.

22. The terminal of claim 21, wherein the terminal configuration failing to match the terminal multi-mode comprises that the terminal does not support the service provided by one or more network standards in the terminal multi-mode, and the processor is configured to:
remove the one or more network standards from the terminal multi-mode.

23. The terminal of claim 22, wherein the terminal configuration failing to match the terminal multi-mode comprises that the terminal currently supports the service provided by the third network standard, and the processor is configured to:
add the third network standard into the terminal multi-mode.

25. A non-transitory computer readable storage medium storing computer programs, the computer programs comprising program instructions which, when executed by a processor, are operable with the processor to perform:
setting a flag for forbidding access to a first network standard for a first target network, and determining a second target network and a second network standard, after failing to access the first target network under the first network standard, wherein the first network standard and the second network standard are determined according to a terminal multi-mode, and the terminal multi-mode indicates network standards that the terminal can access; and
updating the terminal multi-mode according to the second target network and the second network standard, and trying to access the second target network under the second network standard.

26. The non-transitory computer readable storage medium of claim 10, wherein updating the terminal multi-mode according to the second target network and the second network standard comprises:
removing the first network standard from the terminal multi-mode in response to the second target network being the same as the first target network and the second network standard being different from the first network standard.
